(19) United States
(12) Patent Application Publication
(10) Pub. No.: US 2023/0254118 A1
(43) Pub. Date: Aug. 10, 2023

(54) ELECTRONIC DEVICE INCLUDING PARTIAL LEDGER AND METHOD IN BLOCKCHAIN NETWORK

(71) Applicant: Samsung Electronics Co., Ltd., Suwon-si (KR)

(72) Inventors: Byeongyun OH, Suwon-si (KR); Hun KIM, Suwon-si (KR); Gyuhyun SHIN, Suwon-si (KR); Dohyun JO, Suwon-si (KR); Jihwan KIM, Suwon-si (KR); Woongah YOON, Suwon-si (KR); Jinsu JO, Suwon-si (KR); Seungmin HA, Suwon-si (KR)

(21) Appl. No.: 18/300,001

(22) Filed: Apr. 13, 2023

Related U.S. Application Data
(63) Continuation of application No. PCT/KR2022/008316, filed on Jun. 13, 2022.

(30) Foreign Application Priority Data
Jun. 11, 2021 (KR) 10-2021-0076072
Sep. 2, 2021 (KR) 10-2021-0117125

(51) Int. Cl. H04L 9/06; H04L 9/00

(52) U.S. Cl. CPC H04L 9/0643; H04L 9/50

(57) ABSTRACT

According to an embodiment of the disclosure, an electronic device configuring a first block node included in a blockchain network may store a partial ledger including a part of a full ledger regarding the blockchain network, may determine whether data necessary for executing a first smart contract regarding a transaction requested to be performed is stored in a first database, based on a result of the determining, may acquire node information including information regarding at least one block node that stores the data from the third block node through a communication circuit, and may acquire the data from the second block node or the third block node, based on the node information, and may execute the first smart contract.

### CROSS-REFERENCE TO RELATED APPLICATION(S)

This application is a continuation application, claiming priority under § 365(c), of an International application No. PCT/KR2022/008316, filed on Jun. 13, 2022, which is based on and claims the benefit of a Korean patent application number 10-2021-0076072, filed on Jun. 11, 2021, in the Korean Intellectual Property Office, and of a Korean patent application number 10-2021-0117125, filed on Sep. 2, 2021, in the Korean Intellectual Property Office, the disclosure of each of which is incorporated by reference herein in its entirety.

### TECHNICAL FIELD

The disclosure relates to an electronic device which controls execution of a function by using a blockchain network, and an operating method thereof.

More particularly, the disclosure relates to an electronic device which performs an agreement on a transaction between block nodes in a blockchain network including block nodes having partial ledgers, and an operating method thereof.

### BACKGROUND ART

A blockchain network is a network that is distinguished from a centralized network, in which a decision is made by a central server, and is expressed as a decentralized network. The blockchain network refers to a network in which a decision is made according to a consensus algorithm of nodes participating in the blockchain network.

A distributed ledger existing in the blockchain network may include at least one block which is generated based on a transaction executed in the blockchain network, and a database which stores data related to the transaction. The distributed ledger may be stored in respective nodes participating in the blockchain network. The distributed ledger existing in the blockchain network may be refined according to a consensus algorithm of nodes participating in the blockchain network. The distributed ledger may include at least one block connected. Such connection between the blocks may be expressed as a blockchain.

The distributed ledger may be refined according to a consensus algorithm of nodes participating in the blockchain network in order to maintain security and integrity. Specifically, block nodes participating in the blockchain network may perform an endorsement operation, an ordering operation, and a validation operation in order to confirm a block generated based on a transaction.

The above information is presented as background information only to assist with an understanding of the disclosure. No determination has been made, and no assertion is made, as to whether any of the above might be applicable as prior art with regard to the disclosure.

### DISCLOSURE

### Technical Problem

The blockchain network may include blockchain nodes that make a blockchain system effective. The blockchain nodes may be configured with electronic devices.

Nodes participating in the blockchain network should store data regarding a whole blockchain in devices, and should maintain and manage the data for the sake of integrity of blocks. This does not matter if data regarding the whole blockchain is not large, but as the number of blocks increases, the size of data regarding the whole blockchain gradually increases. Accordingly, there is a problem that nodes participating in the blockchain should store, maintain, and manage data of large capacities. If a node participating in the blockchain is a personal mobile device, there is a problem that the device does not reach this level of performance.

In addition, nodes participating in the blockchain network should participate in an agreement operation on a transaction performed in the blockchain network. The nodes participating in the blockchain network should participate in an agreement even if the transaction is not related to the nodes. Accordingly, since central processing unit (CPU) processing and blockchain network communication should be maintained, there is a problem that the respective block nodes should continuously consume power. In addition, since a node randomly communicates with other nodes included in the blockchain network, there may be a problem of security.

Aspects of the disclosure are to address at least the above-mentioned problems and/or disadvantages and to provide at least the advantages described below.

### Technical Solution

In accordance with an aspect of the disclosure, an electronic device configuring a first block node included in a blockchain network is provided. The electronic device includes a communication circuit configured to transmit or receive a signal to or from a second block node or a third block node included in the blockchain network, a memory configured to store a partial ledger including a part of a full ledger regarding the blockchain network, the partial ledger including a first database, and at least one processor electrically connected with the communication circuit and the memory, and the at least one processor may be configured to determine whether data necessary for executing a first smart contract regarding a transaction requested to be performed is stored in the first database, based on a result of the determining, acquire node information including information regarding at least one block node that stores the data from the third block node through the communication circuit, and acquire the data from the second block node or the third block node, based on the node information, and execute the first smart contract.

In accordance with another aspect of the disclosure, an operating method of an electronic device configuring a first block node included in a blockchain network is provided. The operating method includes storing a partial ledger including a part of a full ledger regarding the blockchain network, the partial ledger including a first database, acquiring a request for performing a transaction, determining whether data necessary for executing a first smart contract regarding the transaction is stored in the first database, based on a result of the determining, acquiring node information regarding at least one block node that stores the data from a third block node, acquiring the data from a second block node or the third block node, based on the node information, and executing the first smart contract.

In accordance with another aspect of the disclosure, a blockchain system is provided. The blockchain system includes at least a first electronic device, a second electronic device, and a third electronic device as block chain nodes, wherein the first electronic device includes a partial ledger including a part of a full ledger regarding the block chain system, and a first database, and, in response to a request for performing a transaction being received, the first electronic device is configured to determine whether data necessary for executing a first smart contract regarding the transaction is stored in the first database, wherein the first electronic device is configured to acquire node information including at least one external device which stores the data, from the third electronic device, based on a result of the determining, and wherein the first electronic device is configured to acquire the data based on the node information, and to execute the first smart contract by using the acquired data.

### Advantageous Effects

According to the disclosure, the electronic device may establish a blockchain network with external electronic devices. In this case, the electronic device may store a partial ledger including at least part of a distributed ledger of the blockchain network, so that a memory may be efficiently used.

According to the disclosure, the electronic device may guarantee reliability and integrity regarding blocks included in a partial ledger even if the electronic device stores the partial ledger including at least part of the distributed ledger of the block chain network.

According to the disclosure, the electronic device may maintain the same level of agreement as the level of agreement of a normal blockchain, while storing a partial ledger.

According to the disclosure, the electronic device participates only in processing of a transaction related to the electronic device, so that unnecessary power consumption is reduced and randomly generated communication with other electronic devices is reduced.

According to the disclosure, the electronic device participates only in processing of a transaction related to the electronic device, so that security problem is enhanced.

Other aspects, advantages, and salient features of the disclosure will become apparent to those skilled in the art from the following detailed description, which, taken in conjunction with the annexed drawings, discloses various embodiments of the disclosure.

### DESCRIPTION OF DRAWINGS

The above and other aspects, features, and advantages of certain embodiments of the disclosure will be more apparent from the following description taken in conjunction with the accompanying drawings, in which:

FIG. 1 is a block diagram of an electronic device according to an embodiment of the disclosure;

FIG. 2 is a view provided to explain a blockchain platform of an electronic device according to an embodiment of the disclosure;

FIG. 3 is a view provided to explain a blockchain network according to an embodiment of the disclosure;

FIG. 4 is a view provided to explain a blockchain network including blockchain nodes which store a partial ledger or a full ledger according to an embodiment of the disclosure;

FIG. 5 is a view provided to explain a structure of a blockchain included in a full ledger according to an embodiment of the disclosure;

FIG. 6 is a flowchart illustrating an operation of processing, by an electronic device including a partial ledger, an agreement on a transaction according to an embodiment of the disclosure;

FIG. 7 is a flowchart to explain an operation of executing, by a first block node, a first smart contract according to an embodiment of the disclosure;

FIG. 8 is a flowchart to explain an endorsement operation on a transaction in a blockchain network according to an embodiment of the disclosure;

FIG. 9 is a flowchart to explain an operation of confirming a block in a blockchain network according to an embodiment of the disclosure; and

FIG. 10 is a block diagram of an electronic device in a network environment according to an embodiment of the disclosure.

Throughout the drawings, it should be noted that like reference numbers are used to depict the same or similar elements, features, and structures.

### MODE FOR INVENTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

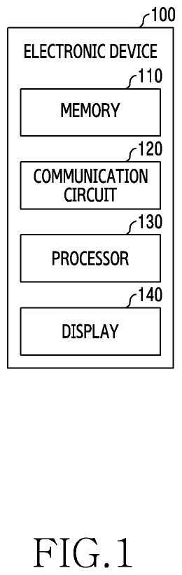

FIG. 1 is a block diagram of an electronic device according to an embodiment of the disclosure.

Referring to FIG. 1, the electronic device 100 may include a memory 110, a communication circuit 120, a processor 130, and a display 140, or a combination of these. In various embodiments, the electronic device 100 may include additional components in addition to the components illustrated in FIG. 1, or may omit at least one of the components illustrated in FIG. 1.

According to an embodiment, the memory 110 may store instructions that, when being executed, cause the processor 130 to process data for performing an operation of the electronic device 100 or to control components of the electronic device 100. The memory 110 may include a secure area or an extra secure storage medium (for example, a secure memory area accessible only through a secure operating system (OS) (for example, a trust zone)). According to another embodiment, the memory 110 may include at least one blockchain application for performing a blockchain-related operation. For example, the memory 110 may include the blockchain application for performing operation related to the blockchain, or a blockchain platform corresponding to a blockchain module.

According to yet another embodiment, the memory 110 may store a distributed ledger regarding a blockchain network. For example, when the electronic device 100 corresponds to a server node in the blockchain network, the memory 110 may store the whole distributed leger regarding the blockchain network. Hereinafter, the whole distributed ledger may be expressed as a full ledger. In addition, the server node of the blockchain network may include a node list including information of block nodes which store data regarding the blockchain network. For example, when the electronic device 100 is the server node, the memory 110 may store the node list. In another example, when the electronic device 100 is a mobile node in the blockchain network, the memory 110 may store a partial ledger including a part of the distributed ledger regarding the blockchain network. Hereinafter, a part of the distributed ledger, which is distinguished from the full ledger, may be expressed as a partial ledger.

According to yet another embodiment, the distributed ledger may include at least one block including at least one transaction in the blockchain network, respectively, and a state database (DB). Hereinafter, the state database may be expressed as a state database or a state DB. According to yet another embodiment, the memory 110 may store a partial leger including at least one block corresponding to at least one transaction, respectively, on which the electronic device 100 participates in an agreement. In addition, the memory 110 may store data regarding at least one transaction on which the electronic device 100 participates in an agreement in the state database. Accordingly, the electronic device 100 may store only the block related to the transaction on which the electronic device 100 participates in an agreement in the memory 110, so that the memory 110 may be efficiently managed.

According to yet another embodiment, the communication circuit 120 may be connected with an external device and may be configured to transmit and receive data. According to yet another embodiment, the electronic device 100 may establish a blockchain network with at least one external device through the communication circuit 120. The blockchain network may include the at least one external device and the electronic device 100 as blockchain nodes. Accordingly, the electronic device 100 and/or the at least one external device may serve as block node, and simultaneously, may serve as clients. In an embodiment, the electronic device 100 may transmit and receive data to and from at least one external device included in the blockchain network through the communication circuit 120, and may reach a transaction agreement in the blockchain network.

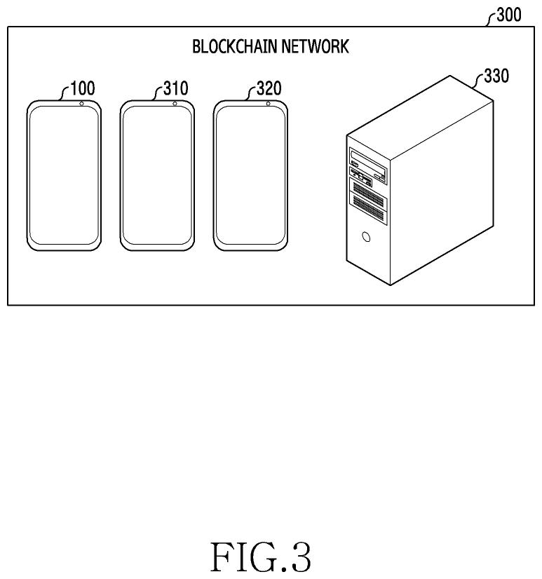

According to various embodiments, the blockchain network may include a server node and/or a mobile node as a blockchain node. According to yet another embodiment, the mobile node may be the electronic device 100 and/or an external electronic device, and may indicate a portable electronic device. For example, the electronic device 100 and/or the external electronic device may be a mobile, a tablet personal computer (PC), and/or a notebook. The blockchain network according to various embodiments will be described in detail below with reference to FIG. 3.

According to yet another embodiment, the processor 130 may be electrically or operatively connected with the memory 110, the communication circuit 120, and the display 140. According to yet another embodiment, the processor 130 may execute computation or data processing related to control and/or communication of at least one other component, by using instructions stored in the memory 110. According to yet another embodiment, the processor 130 may include at least one of a central processing unit (CPU), a graphics processing unit (GPU), a micro controller unit (MCU), a sensor hub, a supplementary processor, a communication processor, an application processor, an application specific integrated circuit (ASIC), field programmable gate arrays (FPGA), and may have a plurality of cores.

According to yet another embodiment, the processor 130 may perform an operation related to the blockchain through a blockchain platform stored in the memory 110. According to yet another embodiment, the processor 130 may acquire a request for performing a transaction. For example, the processor 130 may detect a request for performing a transaction from a user of the electronic device 100.

According to yet another embodiment, the processor 130 may determine data necessary for executing a first smart contract regarding the transaction requested to be performed. In addition, the processor 130 may determine whether the data necessary for executing the first smart contract is stored in the memory 110. For example, the processor 130 may determine whether the data for executing the first smart contract (for example, a read-set) is included in the state database stored in the memory 110. For example, the processor 130 may determine whether data to be read from the state database to execute the first smart contract is stored in the memory 110. In the following descriptions, data necessary for executing a smart contract may correspond to a read-set.

According to yet another embodiment, when all of the data necessary for executing the first smart contract are stored in the state database, the processor 130 may execute the first smart contract based on the stored data.

According to yet another embodiment, when a part of the data necessary for executing the first smart contract is not stored in the state database, the processor 130 may acquire the data from other block nodes included in the blockchain network. According to an embodiment, the processor 130 may acquire information on block nodes that have the data from the server node included in the blockchain network, in order to acquire the data from other block nodes. The processor 130 may request the data from other block nodes based on the information acquired from the server node. For example, when the data necessary for executing the first smart contract is not stored in the state database, the processor 130 may acquire a node list from the server node included in the blockchain network. In addition, the processor 130 may acquire hash information regarding the data from the server node. According to yet another embodiment, the hash information regarding the data may indicate a unique identification value of the data.

According to yet another embodiment, the processor 130 may acquire a data value regarding the data from other block nodes included in the blockchain network, based on the node list and the hash information which are acquired from the server node. For example, the processor 130 may identify at least one block node that stores the data, based on the node list, and may acquire the data from the identified at least one block node, based on the hash information.

According to yet another embodiment, the processor 130 may execute the first smart contract for performing the transaction by using the acquired data.

According to yet another embodiment, as the transaction is executed in the blockchain network, the processor 130 may perform an operation for generating a block which includes a hash field including previous block information in the full ledger and previous block information in the partial ledger stored in the memory 110, and includes block data regarding the transaction. For example, the processor 130 may request a block node included in the blockchain network (for example, a block generation node) to generate the block including transaction data. The block may be confirmed through an agreement with nodes included in the blockchain network through the communication circuit 120. In yet another embodiment, the processor 130 may store the block in the memory 110. For example, the processor 130 may acquire an update request regarding the block confirmed through the agreement from the server node, and may store the block in the memory 110 based on the update request. In this case, the processor 130 may store the block as a block after an end block of the blockchain of the partial ledger.

According to yet another embodiment, the display 140 may display various contents (for example, a text, an image, a video, an icon and/or a symbol). According to yet another embodiment, the display 140 may include a liquid crystal display (LCD), a light emitting diode (LED) display, or an organic LED (OLED) display.

According to yet another embodiment, the processor 130 may display various contents related to the blockchain application through the display 140. For example, the processor 130 may display a content indicating a success or failure notification regarding the transaction requested to be performed, through the display 140. For example, when an endorsement operation, a validation operation and/or an ordering operation for the transaction agreement fails, the processor 130 may stop the transaction agreement operation and may display a notification regarding the failure in generating a block through the display 140. According to various embodiments, the processor 130 is not limited to the display 10, and may output the failure notification by using various configurations included in the electronic device 100.

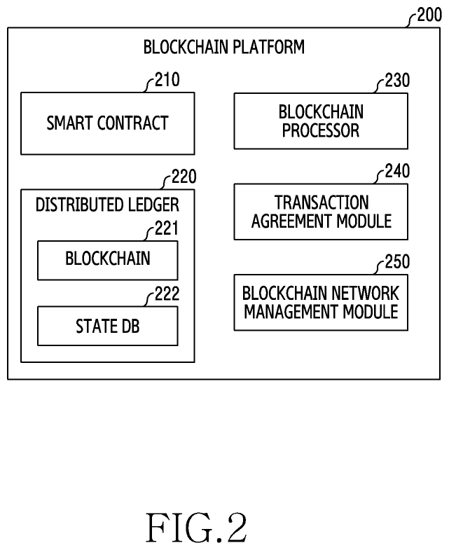

FIG. 2 is a view provided to explain a blockchain platform of an electronic device according to an embodiment of the disclosure.

Referring to FIG. 2, the electronic device 100 may include a blockchain platform 200. According to an embodiment, the blockchain platform 200 may correspond to a blockchain application which is stored in the memory 110 to perform operation related to a blockchain, or a blockchain module perform operation related to blockchain.

According to another embodiment, the blockchain platform 200 may include a smart contract 210, a distributed ledger 220, a blockchain processor 230, a transaction agreement module 240, and a blockchain network management module 250. According to various embodiments, the blockchain platform 200 may further include various components to perform the blockchain-related operation, or may omit some components.

According to yet another embodiment, the blockchain processor 230 may be included in the processor 130. The blockchain processor 230 may control operations of components included in the blockchain platform 200. For example, the blockchain processor 230 may perform execution of a transaction including ledger synchronization, transaction signature and/or transaction recording performance on the blockchain network.

According to yet another embodiment, the blockchain platform 200 may include the smart contract 210. The blockchain processor 230 may provide the smart contract 210 with a value (for example, a read-set) necessary for executing the smart contract 210 regarding the transaction. In addition, the blockchain processor 230 may store a value (for example, a write-set) outputted by executing the smart contract 210. For example, the blockchain processor 230 may provide data and factors for executing the smart contract 210. According to yet another embodiment, as the smart contract 210 is executed, a data (required data) set (for example, a read-set) that should be read to execute the smart contract 210, and a data set (for example, a write-set) that includes a resulting value of execution of the smart contract 210 may be returned.

In yet another embodiment, the distributed ledger 220 may include a blockchain 221 and a state database 222. According to yet another embodiment, the distributed ledger 220 may store data regarding a transaction related to the electronic device 100 in the blockchain network. For example, the distributed ledger 220 may store a block and data based on the transaction on which the electronic device 100 participates in an agreement. According to yet another embodiment, the distributed ledger 220 may be a partial ledger that includes at least part of a full ledger of the blockchain network. For example, the distributed leger may be a partial ledger that stores a block and data regarding a transaction related to the electronic device 100, in the full ledger which stores blocks and data related to all transactions in the blockchain network.

According to yet another embodiment, the blockchain 221 may include at least one block generated though the blockchain network. The block may include a block header and transaction data. According to yet another embodiment, the block header may include at least one of a hash value of a header and data area, a hash value of a previous block, a height value of the block, a hash value of state data after the transaction included in the block is performed, a public key of a block generator, a value of signing a hash with a private key of the block generator, an attestation key certificate chain or a value of signing a hash value with an attestation key.

Block data may include at least one of a hash value of at least part of the transaction data, version information of the smart contract, a smart contract identifier (ID), a smart contract function ID, smart contract data which is a factor value necessary for the smart contract function, a nonce value which is a transaction generation number of a transaction generator, a public key of the transaction generator, a value of signing a hash value with a private key of the transaction generator, an attestation key certificate chain or a value of signing a hash value with an attestation key.

In yet another embodiment, the blocks of the distributed ledger 220 may be formed in a chain shape, and block data may be stored in the distributed ledger 220. For example, at least one block included in the blockchain 221 may include a hash field and block data. According to yet another embodiment, the hash field may include previous block information in the full ledger of the blockchain network, and previous block information in the partial ledger of the blockchain network. In yet another embodiment, the block data may include transaction data regarding the corresponding block.

According to yet another embodiment, at least one block included in the blockchain 221 may be expressed as being connected based on previous block information included in the hash field. For example, at least one block included in the blockchain 221 may be connected in a directed acrylic graph (DAG) structure. According to yet another embodiment, when at least one block included in the full ledger of the blockchain network is connected in the DAG structure, a partial ledger of the blockchain network may be connected in a sub-graph structure of the full ledger.

In yet another embodiment, the state database 222 may store values which are changed by execution of the transaction in the blockchain network in the form of a key value. According to yet another embodiment, the form of the key-value may include a key of the data, a data value, a hash regarding the data, information and block number of a block node owning the data in the blockchain network. In yet another embodiment, data stored in the state database 222 may be expressed as state data. The state data may refer to, for example, data stored in a world state which is a database used in a hyper ledger fabric. However, this should not be considered as limiting.

The state database 222 is a kind of database used in the hyper ledger fabric, and may store final values which are changed by execution of the transaction in the form of a key value. Accordingly, the electronic device 100 may identify the state database 222 in order to identify final values obtained by execution of the transaction in the blockchain network.

According to yet another embodiment, the state database 222 may store data regarding a transaction that the user of the electronic device 100 is involved in. For example, the state database 222 may store values which are changed by execution of the transaction related to the electronic device 100 in the blockchain network.

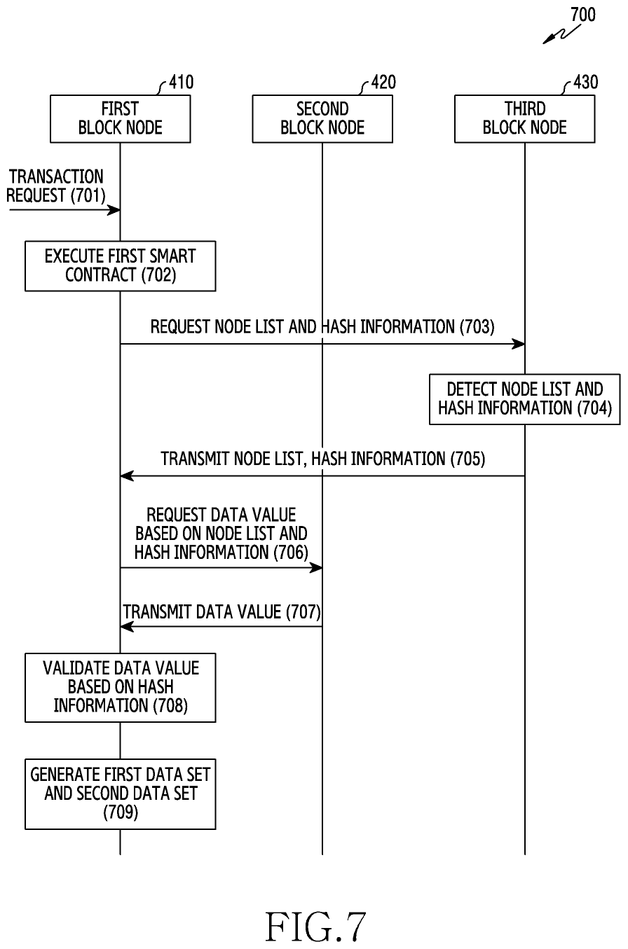

According to yet another embodiment, the transaction agreement module 240 may control an operation for processing a transaction agreement by the electronic device 100 in the blockchain network. For example, the transaction agreement module 240 may perform an operation of processing a transaction agreement based on a consensus algorithm used in the blockchain network. The transaction agreement module 240 may support various consensus algorithms used in a typical blockchain. For example, the transaction agreement module 240 may perform a transaction agreement with nodes included in the blockchain network, based on a proof of work (POW), a proof of stake (POS), practical byzantine fault tolerance (PBFT), RAFT. According to an embodiment, the operation of performing the transaction agreement through the transaction agreement module 240 in the blockchain network will be described with reference to FIGS. 7 to 9.

According to yet another embodiment, the blockchain network management module 250 may perform an operation related to the blockchain network in which the electronic device 100 participates as a node. According to yet another embodiment, the blockchain network management module 250 may establish the blockchain network, and may perform an operation related to other nodes (external devices) included in the blockchain network.

As described above, an electronic device (for example, the electronic device 100 of FIG. 1) configuring a first block node included in a blockchain network may include: a communication circuit (for example, the communication circuit 120 of FIG. 1) configured to transmit or receive a signal to or from a second block node (for example, the first external device 310 of FIG. 3) or a third block node (for example, the third external device 330 of FIG. 3) included in the blockchain network (for example, the blockchain network 300 of FIG. 3); a memory (for example, the memory 110 of FIG. 1) configured to store a partial ledger (for example, the distributed ledger 220 of FIG. 2) including a part of a full ledger regarding the blockchain network, the partial ledger including a first database (for example, the state database 222 of FIG. 2); and at least one processor (for example, the processor 130 of FIG. 1) electrically connected with the communication circuit and the memory, and the at least one processor may determine whether data necessary for executing a first smart contract (for example, the smart contract 210 of FIG. 2) regarding a transaction requested to be performed is stored in the first database, based on a result of the determining, may acquire node information including information regarding at least one block node that stores the data from the third block node through the communication circuit, and may acquire the data from the second block node or the third block node, based on the node information, and execute the first smart contract.

According to yet another embodiment, the partial ledger may include at least one block corresponding to at least one transection, on which the electronic device participates in an agreement, and the at least one block may include a block hash including previous block information in the full ledger and previous block information in the partial ledger, and block data.

According to yet another embodiment, the first database may store state data related to the at least one transaction.

According to yet another embodiment, the third block node may include the full ledger including a second database, the second database may store all state data regarding the blockchain network, and the at least one processor may acquire the data from the third block node when the data is stored in the second database.

According to yet another embodiment, the at least one processor may acquire hash information regarding the data from the third block node through the communication circuit, along with the node information, may transmit a first data set and an endorsement request including the transaction to the second block node, may receive an endorsement result including a second data set generated based on the endorsement request, and the first data set, from the second block node, and may validate the endorsement result based on the hash information, and the first data set may include data required to execute the first smart contract, and the second data set may include data to be stored in the first database, based on execution of the first smart contract.

According to yet another embodiment, the second data set may be generated by the second block node executing a second smart contract based on the first data set.

According to yet another embodiment, the at least one processor may generate transaction data regarding the transaction, based on the first data set and the second data set, with the endorsement result being validated, may transmit a block generation request including the first data set, the second data set, and the transaction data to the third block node, may receive an update request regarding the partial ledger and the first database, which is generated based on the block generation request, from the third block node, and may update the partial ledger and the first database based on the update request.

According to yet another embodiment, the update request may be generated based on a result of comparing the first data set and the second data set which are generated from the third block node, and at least one of the hash information, block order information, the node list which are stored in the third block node.

As described above, an operating method of an electronic device (for example, the electronic device 100 of FIG. 3) configuring a first block node included in a blockchain network (for example, the blockchain network 300 of FIG. 3) may include: storing a partial ledger including a part of a full ledger regarding the blockchain network, the partial ledger including a first database; acquiring a request for performing a transaction; determining whether data necessary for executing a first smart contract regarding the transaction is stored in the first database; based on a result of the determining, acquiring node information regarding at least one block node that stores the data from a third block node; acquiring the data from a second block node or the third block node, based on the node information; and executing the first smart contract.

According to yet another embodiment, the partial ledger may include at least one block corresponding to at least one transection, on which the electronic device participates in an agreement, and storing may include: storing the at least one block including a block hash including previous block information in the full ledger and previous block information in the partial ledger, and block data; and storing state data related to the at least one transaction.

According to yet another embodiment, the third block node may include the full ledger including a second database which stores all state data regarding the blockchain network, and acquiring the data may include acquiring the data from the third block node in response to the data being stored in the second database.

The method may further include: transmitting a first data set and an endorsement request including the transaction to the second block node; receiving an endorsement result including a second data set generated based on the endorsement request, and the first data set, from the second block node; and validating the endorsement result based on hash information regarding the first data set and the second data set, and the first data set may include data required to execute the first smart contract, and the second data set may include data to be stored in the first database, based on execution of the first smart contract.

According to yet another embodiment, the second data set may be generated by the second block node executing a second smart contract based on the first data set.

According to yet another embodiment, the method may further include: generating transaction data regarding the transaction, based on the first data set and the second data set, with the endorsement result being validated; transmitting a block generation request including the first data set, the second data set, and the transaction data to the third block node; receiving an update request regarding the partial ledger and the first database, which is generated based on the block generation request, from the third block node; and updating the partial ledger and the first database, based on the update request.

According to yet another embodiment, the update request may be generated based on a result of comparing the first data set and the second data set which are generated from the third block node, and at least one of the hash information, block order information, the node list which are stored in the third block node.

As described above, in a blockchain system (for example, the blockchain network 300) including at least a first electronic device (for example, the electronic device 100 of FIG. 3), a second electronic device (for example, the first external device 310 or the second external device 320 of FIG. 3), and a third electronic device (for example, the third external device 330 of FIG. 3) as block chain nodes, the first electronic device may include a partial ledger including a part of a full ledger regarding the block chain system, and a first database, and, in response to a request for performing a transaction being received, the first electronic device may determine whether data necessary for executing a first smart contract regarding the transaction is stored in the first database, the first electronic device may acquire node information including at least one external device which stores the data, from the third electronic device, based on a result of the determining, and the first electronic device may acquire the data based on the node information, and may execute the first smart contract by using the acquired data.

According to yet another embodiment, the first electronic device may transmit a first data set and an endorsement request including the transaction to the second electronic device, the second electronic device may generate a second data set based on the endorsement request, and may transmit an endorsement result including the second data set and the first data set to the first electronic device, the first electronic device may validate the endorsement result, and the first data set may include data required to execute the first smart contract, and the second data set may include data to be stored in the first database, based on execution of the first smart contract.

According to yet another embodiment, the first electronic device may generate transaction data corresponding to the transaction, based on the first data set and the second data set, based on the endorsement result, the first electronic device may transmit a block generation request including the first data set, the second data set, and the transaction data to the third electronic device, and the third electronic device may compare the first data set and the second data set, and at least one of hash information, block order information, and the node list regarding the data which are stored in a memory of the third electronic device, and may confirm the block based on a result of the comparing.

According to yet another embodiment, in response to the block being confirmed, the third electronic device may request electronic devices related to the transaction to update according to the confirmed block, among at least one electronic device included in the blockchain system as a blockchain node.

According to yet another embodiment, the full ledger of the blockchain system may include at least one block corresponding to at least one transaction regarding the blockchain system, respectively, the at least one block may include a block hash including previous block information in the full ledger and previous block information in the partial ledger, and the at least one block may be connected in a directed acyclic graph (DAG) structure.

FIG. 3 is a view provided to explain a blockchain network according to an embodiment of the disclosure.

Referring to FIG. 3, a plurality of electronic devices 100, 310, 320, 330 may constitute a blockchain network 300. The plurality of electronic devices 100, 310, 320, 330 constituting the blockchain network 300 may include portable electronic devices. For example, the plurality of electronic devices 100, 310, 320, 330 may correspond to mobiles, tablet PCs, and/or notebooks. According to an embodiment, the electronic device 100, the first external device 310, and the second external device 320 may be portable mobile nodes, and the third external device 330 may be a server node. According to various embodiments, the blockchain network 300 may include a plurality of server nodes which are similar to the third external device 330.

According to another embodiment, the plurality of electronic devices 100, 310, 320, 330 may include configurations similar to that of the electronic device 100. For example, the plurality of electronic devices 100, 310, 320, 330 may be configured to perform operations necessary for the blockchain network, and may include configurations similar to the blockchain platform 200.

Although it is illustrated that the four electronic devices constitute the blockchain network for convenience of explanation, this should not be considered as limiting.

In yet another embodiment, the third external device 330 may be a server node. The third external device 330 serving as a server node may store a full ledger of the blockchain network 300. According to yet another embodiment, the third external device 330 may agree on all transactions in the blockchain network 300 and may record all blocks. For example, the third external device 330 may participate in an agreement on all transactions, and may store blocks and state data of all transactions of the blockchain network 300 in a memory. Accordingly, the third external device 330 may store the full ledger which is a distributed ledger of the blockchain network 300 in the memory.

According to yet another embodiment, the electronic device 100, the first external device 310 and/or the second external device 320 may be mobile nodes of the blockchain network 300. According to yet another embodiment, the electronic device 100, the first external device 310 and/or the second external device 320 serving as mobile nodes may generate transactions related to respective devices among all of the transactions of the blockchain network 300, and may record blocks. For example, the electronic device 100, the first external device 310 and/or the second external device 320 may participate in an agreement on transactions related to the respective devices, and may store only the blocks and the state data of the transactions related to the respective devices in memories of the respective devices. For example, the electronic device 100 may participate in an agreement on a transaction related to the electronic device 100 and/or a user of the electronic device 100, and may store only the block and the state data of the transaction in a memory 110. Accordingly, the electronic device 310, the first external device 310, and/or the second external device 320 may store, in their respective memories, a partial ledger that stores only the block and the state data of a transaction in which the electronic device 100, the first external device 310 and/or the second external device 320 participate, respectively, in the full ledger of the blockchain network 300.

According to yet another embodiment, the electronic device 100, the first external device 310 and/or the second external device 320 may participate only in an agreement of a transaction that the user of each device is involved in, and may store data generated by execution of the transaction in their respective state databases. For example, the electronic device 100 may participate only in an agreement of a transaction that the user of the electronic device 100 is involved in, and may store data generated by execution of the transaction in the state database 222. According to yet another embodiment, when a block is confirmed by execution of the transaction, the third external device 330 may request a device that is involved in the transaction among the electronic device 100, the first external device 310 and/or the second external device 320 to update the distributed ledger.

According to yet another embodiment, the plurality of electronic devices 100, 310, 320, 330 may execute smart contracts for executing transactions independently and respectively. In yet another embodiment, the smart contract may execute the same program logic for processing the transaction. Nodes included in the blockchain network 300 according to yet another embodiment may be configured to participate only in execution of transactions related to the respective devices. For example, the electronic device 100, the first external device 310, and/or the second external device 320 corresponding to a mobile node may participate only in execution of a transaction related to each device. However, the server node may participate in execution of all transactions.

In yet another embodiment, the plurality of electronic devices 100, 310, 320, 330 may refer to state data stored in the state database included in at least one of the plurality of electronic devices 100, 310, 320, 330 in order to execute the smart contract. According to yet another embodiment, the plurality of electronic devices 100, 310, 320, 330 may execute smart contracts based on the state data, respectively, and may determine whether to execute a transaction, based on a result of a consensus process performed among the plurality of electronic devices 100, 310, 320, 330. For example, when resulting values generated by executing the smart contracts by the plurality of electronic devices 100, 310, 320, 330 are identical, it may be determined that the electronic devices succeed in an agreement. A block regarding a transaction may be generated through an agreement between devices related to execution of the transaction among the plurality of electronic devices 100, 310, 320, 330. According to yet another embodiment, the generated block may be added to the blockchain of the distributed ledger which is stored in each of the devices related to execution of the transaction. For example, the added block may be connected as a block after an end block of the blockchain of the distributed ledger.

According to yet another embodiment, a key value that is stored in the state database of each of the devices related to execution of the transaction among the plurality of electronic devices 100, 310, 320, 330 may be updated by execution of the transaction. Since nodes of the blockchain network 300 according to yet another embodiment participate only in execution of the transaction related to each device, the nodes may store the state data regarding the transaction related to each device. Accordingly, the nodes of the blockchain network 300 may update the state data when the transactions related to each of the devices is executed, without having to update the state database according to execution of all transactions.

The distributed leger of the blockchain network 300 according to yet another embodiment may have a structure similar to the distributed ledger 220 described above with reference to FIG. 2. According to yet another embodiment, the distributed ledger of the blockchain network 300 may include a blockchain and a state database. As the transaction is executed in the blockchain network 300, the blockchain may include at least one block including a hash field including previous block information in the full ledger and previous block information in the partial ledger, and block data regarding the transaction.

According to yet another embodiment, all blockchain nodes included in the blockchain network 300 may own a full ledger or a partial ledger, respectively. According to yet another embodiment, at least one block included in the full ledger or partial edger may be connected by using a hash field. Accordingly, when connection based on the hash field is disconnected or a different distributed leger is found, the blockchain nodes may doubt reliability and validity of the corresponding block.

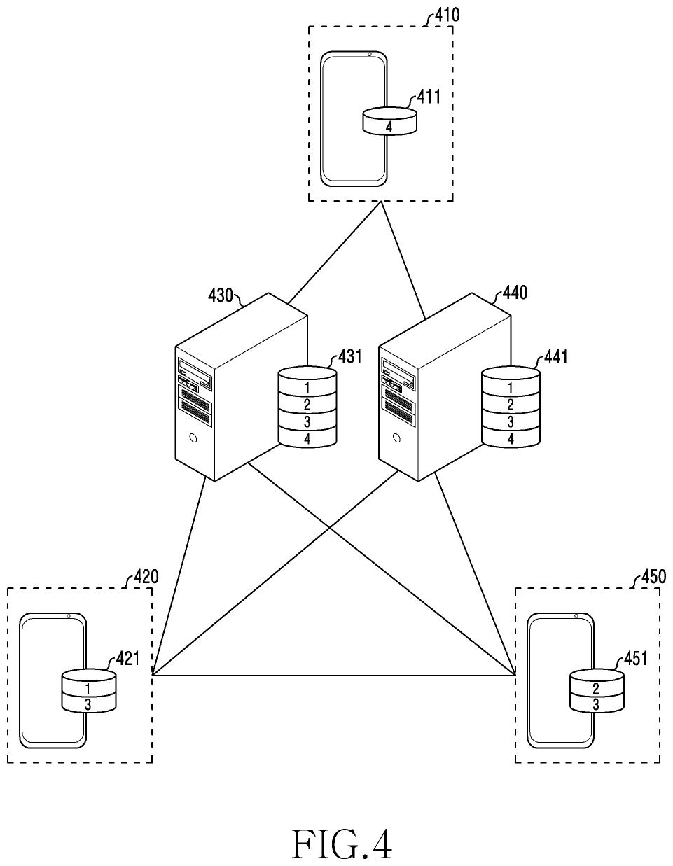

FIG. 4 is a view to explain a blockchain network including blockchain nodes which store a partial ledger or a full ledger according to an embodiment of the disclosure.

Referring to FIG. 4, the blockchain network (for example, the blockchain network 300 of FIG. 3) may include a plurality of electronic devices as block nodes constituting the blockchain network. For example, the blockchain network may include a first block node 410, a second block node 420, a third block node 430, a fourth block node 440, and/or a fifth block node 450, as blockchain nodes. According to an embodiment, the first to fifth block nodes 410-450 may include a similar configuration to that of the electronic device 100. For example, the first to fifth block nodes 410-450 may include a configuration for performing a similar operation to that of the blockchain platform 200, respectively.

According to another embodiment, the first block node 410, the second block node 420, and the fifth block node 450 may be configured as mobile nodes. In addition, the third block node 430 and the fourth block node 440 may be configured as server nodes. According to yet another embodiment, the first block node 410, the second block node 420, and the fifth block node 450 may indicate portable electronic devices. For example, the first block node 410, the second block node 420, and the fifth block node 450 may correspond to mobiles, tablet PCs, and/or notebooks. According to yet another embodiment, the third block node 430 and the fourth block node 440 may be server nodes and may be electronic devices having large memory capacities compared to the first block node 410, the second block node 420, and the fifth block node 450.

According to yet another embodiment, the first to fifth block nodes 410-450 included in the blockchain network may communicate with one another. Accordingly, the first to fifth block nodes 410-450 may perform operations necessary for executing transactions, by using communication circuits (for example, the communication circuit 120 of FIG. 1) included in the respective devices. For example, the first to fifth block nodes 410-450 may perform an operation of agreeing on the transactions by using the respective communication circuits.

According to yet another embodiment, blocks generated in the blockchain network may be included in a distributed ledger, which has been described with reference to FIGS. 2 and 3. For example, when first to fourth blocks are generated in the blockchain network, the distributed leger may include the first to fourth blocks. According to yet another embodiment, the first to fourth blocks may be generated based on execution of a first transaction to a fourth transaction, respectively. According to various embodiments, the first to fourth blocks may be generated based on execution of at least one transaction, respectively.

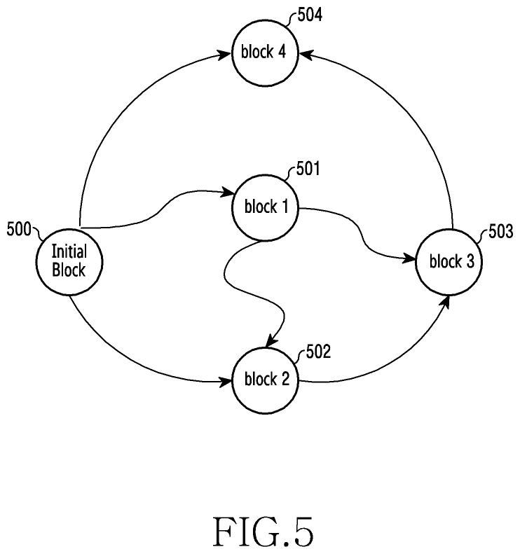

According to yet another embodiment, at least one block included in the distributed ledger may be similar to the configuration of the block described with reference to FIGS. 2 and 3. For example, the block may include a hash field including information of a previous block and block data including transaction data of the block. According to yet another embodiment, at least one block included in the distributed ledger of the blockchain network may be connected in a directed acrylic graph (DAG) structure, based on the previous block information included in the hash field. Configurations of the first to fourth blocks and a connection structure will be described below with reference to FIG. 5.

According to yet another embodiment, the first to fifth block nodes 410-450 may include at least part of the distributed ledger of the blockchain network, respectively. For example, each of the first block node 410, the second block node 420, and the fifth block node 450 may store a partial ledger including a part of the full ledger of the blockchain network in a memory (for example, the memory 110 of FIG. 1). For example, the third block node 430 and the fourth block node 440 may store the full ledger of the blockchain network in memories.

According to yet another embodiment, block nodes storing a partial ledger may store a partial ledger including blocks regarding a transaction related to each block node. According to yet another embodiment, it may be determined whether the transaction is related to each block node, according to whether data necessary for executing the transaction is stored in the memory of the node, whether a user of the node requests generation of the transaction, and/or whether the block node participates in an agreement based on the transaction. According to yet another embodiment, the first block node 410 may be related to a fourth transaction. The second block node 420 may be related to a first transaction and a third transaction. The fifth block node 450 may be related to a second transaction and the third transaction.

According to yet another embodiment, it may be determined that server nodes of the blockchain network are related to all transactions executed in the blockchain network. In yet another embodiment, the server nodes may participate in an agreement on all transactions of the blockchain network. Accordingly, the third block node 430 and the fourth block node 440 may be related to the first to fourth transactions, respectively.

According to yet another embodiment, the first to fifth block nodes 410-450 included in the blockchain network may include blocks which are based on the transactions related to the respective nodes, and state databases which store data regarding the transactions related to the respective nodes. For example, the first to fifth block nodes 410-450 may store ledgers including the blockchains including the blocks, and the state databases in their respective memories.

For example, the first block node 410 may store, in the memory, a first partial ledger 411 which includes a fourth block based on the fourth transaction, and data regarding the fourth transaction. For example, the second block node 420 may store, in the memory, a second partial ledger 421 which includes a first block and a third block generated based on the first transaction and the third transaction, respectively, and includes data regarding the first transaction and the third transaction. For example, the third block node 430 and the fourth block node 440, which are server nodes, may participate in a block agreement on execution of all transactions of the blockchain network. Accordingly, the third block node 430 may store, in the memory, a third full ledger 431 which includes first to fourth blocks generated based on the first to fourth transactions, respectively, and includes the state database of the blockchain network. In addition, the fourth block node 440 may store, in the memory, a fourth full ledger 441 which includes the first to fourth blocks generated based on the first to fourth transactions, respectively, and includes the state database of the blockchain network. According to yet another embodiment, the third full ledger 431 and the fourth full ledger 441 may correspond to the distributed ledger of the blockchain network. Accordingly, the third block node 430 and the fourth block node 440 may store the same full ledger. For example, the fifth block node 450 may store, in the memory, a fifth partial ledger 451 which includes the second block and the third block generated based on the second transaction and the third transaction, respectively, and includes data regarding the first transaction and the third transaction.

FIG. 5 is a view to explain a graph structure of blocks included in a full ledger according to an embodiment of the disclosure.

Referring to FIG. 5, a connection structure of the blocks included in the distributed ledger of the blockchain network described with reference to FIG. 4 is illustrated. The distributed ledger of the blockchain network may include an initial block 500 and first to fourth blocks 501-504. According to yet another embodiment, a block regarding a transaction related to generation of the blockchain network may be included as an initial block 500 among blocks included in the blockchain of the ledger. The block initially generated among the blocks included in the blockchain may be expressed as a blockchain genesis block. In yet another embodiment, the initial block 500 may correspond to a root node according to a graph expressing the connection structure of blocks included in the distributed ledger. According to yet another embodiment, the first to fourth blocks 501-504 may be blocks that are generated based on first to fourth transactions, respectively.

According to yet another embodiment, the distributed ledger may include the initial block 500 and the first to fourth blocks 510-504 connected in a DAG structure. For example, the initial block 500 and the first to fourth blocks 501-504 may correspond to nodes of the DAG graph, respectively. According to yet another embodiment, the connection structure of the initial block 500 and the first to fourth blocks 501-504 may be formed based on information of hash fields included in the respective blocks. According to yet another embodiment, each of the blocks may include a block hash including information regarding the corresponding block. For example, the initial block 500 may include an initial block hash indicating the initial block 500. In addition, the hash field included in each block may include a block hash indicating previous block information in the full ledger, and a block hash indicating previous block information in a partial ledger. For example, at least one block connected by using the initial block 500 as a previous block in the full ledger or partial ledger may include hash information regarding the initial block 500 in a hash field. Accordingly, the full ledger or partial ledger may be a structure in which a hash field of a next block is connected by using a block hash included in a corresponding block.

According to yet another embodiment, as the next block including the hash information included in the previous block is generated, the previous block and the next block may be connected. Accordingly, connection by using the hash information may be expressed as being connected toward another block according to a directed acrylic graph.

According to yet another embodiment, the initial block 500, which is a genesis block, may correspond to a root node, and the initial block 500 may be expressed as being connected in a direction toward the fourth block 504, the first block 501, and the second block 502. For example, the first block 501, the second block 502, and the fourth block 504 may include hash information regarding the initial block 500, as information of a previous block. According to yet another embodiment, the first block 501 may be connected in a direction toward the third block 503 and the second block 502. For example, the third block 503 and the second block 502 may include hash information regarding the first block 501. According to yet another embodiment, the second block 502 may be connected in a direction toward the third block 503. For example, the third block 503 may include hash information regarding the second block 502. According to yet another embodiment, the third block 503 may be connected in a direction toward the fourth block 504. For example, the fourth block 504 may include hash information regarding the third block 503.

According to yet another embodiment, the block nodes included in the blockchain network may store at least part of the distributed ledger in memories, respectively. For example, server nodes (for example, the third block node 430, the fourth block node 440 described with reference to FIG. 4) may store the whole distributed leger in their respective memories. According to yet another embodiment, mobile nodes (for example, the first block node 410, the second block node 420, and the fifth block node 450 described with reference to FIG. 4) may store a part of the distributed leger in their respective memories. In this case, a partial ledger including only blocks based on a transaction related to a mobile node may be stored in a memory. In addition, the mobile node may store a part of the distributed leger in the memory in a sub-graph structure.

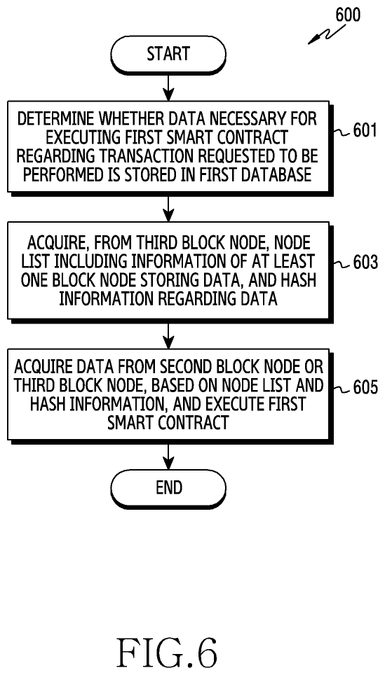

FIG. 6 is a flowchart illustrating an operation of processing, by an electronic device including a partial ledger, an agreement on a transaction according to an embodiment of the disclosure.

According to an embodiment, a blockchain network including the electronic device 100 as a block node may include a plurality of block nodes. For example, the blockchain network may include the third block node 430 described in FIG. 4, as a server node. Accordingly, the third block node may include a full ledger regarding the blockchain network. The third block node may include a node list indicating information regarding which block node stores state data regarding the blockchain network. In addition, the third block node may include hash information regarding data necessary for executing a first smart contract. According to another embodiment, a block node including data means that the data is stored in a memory of an electronic device corresponding to the block node.

Referring to FIG. 6, in operation 601, the processor 130 may determine whether data necessary for executing the first smart contract regarding a transaction requested to be performed is stored in a first database. According to yet another embodiment, the electronic device 100 may be a block node of the blockchain network, and the processor 130 may acquire a request for performing a transaction. The processor 130 may determine whether data necessary for executing a smart contract regarding the transaction requested to be performed is included in the distributed ledger 220. For example, the processor 130 may determine whether the data necessary for executing the first smart contract is stored in the state database 222.

According to yet another embodiment, in operation 603, the processor 130 may acquire information regarding at least one block node that stores the data, from the third block node. For example, the processor 130 may, from the third block node, a node list including information of at least one block node which stores the data necessary for executing the first smart contract, and hash information regarding the necessary data. For example, the processor 130 may transmit a signal for requesting the node list and the hash information to the third block node, and, in response to the request, the third block node may transmit the node list and the hash information to the electronic device 100.

According to yet another embodiment, in operation 605, the processor 130 may acquire the data from the second block node or the third block node, based on the node list and the hash information, and may execute the first smart contract. For example, the processor 130 may determine which node owns the data, based on the node list. Accordingly, the processor 130 may request and acquire the data from the block node owning the data. For example, when the block node owning the data is the second block node 420 included in the blockchain network, the processor 130 may request the data from the second block node 420. In response to the request, the second block node 420 may transmit data included in the partial ledger stored in the second block node 420 to the electronic device 100.

In another example, when the third block node 430 owns the data, the processor 130 may acquire the data from the third block node 430. For example, when the third block node 430 stores not only a key value of the data, hash information but also a real data value of the data, the processor 130 may acquire the node list and the hash information in operation 603, and may acquire the value of the data from the third block node 430 in operation 605.

According to yet another embodiment, when the data necessary for executing the first smart contract is stored in a plurality of block nodes, the processor 130 may acquire all of the data from one block node. In another example, the processor 130 may acquire the data from the plurality of block nodes in a round robin method.

According to yet another embodiment, when the data necessary for executing the first smart contract is stored in the first database in operation 601, the processor 130 may execute the first smart contract by using data stored in the first database.

According to yet another embodiment, as the first smart contract regarding the transaction requested to be performed is executed, the processor 130 may generate a first data set (for example, a read-set) including data that should be read (is necessary) in order to execute the first smart contract, and a second data set (for example, a write-set) including data that should be updated for the state database as the first smart contract is executed.

According to yet another embodiment, block nodes included in the blockchain network may compare the second data sets which are generated as a result of executing smart contracts, respectively. For example, the block nodes may agree on the second data set which is generated as the smart contract is executed based on the shared first data set. According to yet another embodiment, agreeing on the second data set may indicate an operation of determining whether the second data sets regarding the respective block nodes, which are results of smart contracts included in the respective block nodes, are identical. For example, agreeing on the second data set may indicate an operation of determining whether the second data sets generated by the block nodes by executing the smart contract based on the shared first data set include the same value. According to yet another embodiment, when the agreement fails, for example, when it is determined that the second data sets generated from the respective block nodes are different, the processor 130 may finish performing the transaction.

In another example, when it is determined that the second data sets generated from the respective block nodes are identical, that is, when the agreement succeeds, the processor may perform an operation of generating a block based on the first data set and the second data set. For example, the processor 130 may transmit transaction data including the first data set and the second data set to the third block node 430. In yet another embodiment, the processor 130 may request the third block node to generate a block in order to generate and confirm the block regarding the requested transaction. According to yet another embodiment, when the block regarding the requested transaction is generated and confirmed through the third block node, the block nodes participating in the performance of the transaction may update the partial ledger or the full ledger stored in the respective block nodes, based on the generated block.

An operation of performing a transaction agreement in a blockchain network according to an embodiment will be described in detail with reference to FIGS. 7 to 9.

FIG. 7 is a flowchart to explain an operation of executing, by a first block node 410, a first smart contract according to an embodiment of the disclosure.

Referring to FIG. 7, in a method 700, a blockchain network including a first block node 410, a second block node 420, and a third block node 430 as block nodes is illustrated. According to an embodiment, the first block node 410, the second block node 420, and the third block node 430 may include the same/similar configuration as/to the configuration described with reference to FIG. 4. A redundant explanation thereof is omitted. For example, the first block node 410 may be the electronic device 100, and the second block node 420 and the third block node 430 may include a similar configuration to that of the electronic device 100. The first block node 410 and the second block node 420 may be expressed as mobile nodes, and the third block node 430 may be expressed as a server node. According to another embodiment, the first to third block nodes 410-430 may include a ledger regarding the blockchain network, respectively. For example, the first block node 410 may include a first partial ledger, the second block node 420 may include a second partial ledger, and the third block node 430 may include a full ledger.

According to yet another embodiment, the first and second block nodes 410 and 420 may include a partial ledger that has the structure of the distributed ledger described with reference to FIG. 2. The third block node 430, which is a server node, may include a full ledger regarding the blockchain network. According to yet another embodiment, a state database included in each of the first to third block nodes 410-430 may include at least one of a key value, a data value, hash information, node information, and/or block number.

TABLE 1

| | | Hash | Node | Block |
|---|---|---|---|---|
| Key Value | Date Value | Information | Information | Number |
| D1 Budget | 2 hundred | 387343 | First block | 2 |
| | million | | node, second | |
| | | | block node | |
| D1 Development | [D1 Plan] | 088722 | First block | 1 |
| Planning | | | node | |

TABLE 2

| | | Hash | Node | Block |
|---|---|---|---|---|
| Key Value | Data Value | Information | Information | Number |
| D1 Budget | 2 hundred | 387343 | First block | 2 |
| | million | | node, second | |
| | | | block node | |
| D2 Budget | 1 hundred | 154254 | Second block | 3 |
| | million | | node | |
| Total Budget | 3 hundred | 767673 | Second block | 4 |
| | million | | node | |

According to yet another embodiment, Table 1 shows state data which is stored in the state database included in the first block node 410. In addition, Table 2 shows state data which is stored in the state database included in the second block node 420. According to yet another embodiment, the key value may indicate key information of the state data. For example, when the state data indicates information regarding ‘budget of D2’, the key value may be expressed as ‘D2 Budget’. According to yet another embodiment, the data value may indicate a real value of the state data. For example, when the key value is ‘D2 Budget’, the data value may indicate a budget value (for example, 2 hundred million) of real D2. According to yet another embodiment, the hash information may be a unique value regarding the state data, and may be determined according to generation and/or update of data. According to yet another embodiment, since the state data may be changed based on generation of a block, the processor 130 may determine whether the state data is modified through the hash information. According to yet another embodiment, the node information may include information regarding other block nodes of the blockchain network that store the state data. For example, when the first block node 410 and the second block node 420 store ‘D2 Budget’ data, the node information may include information regarding the first block node 410 and the second block node 420. According to yet another embodiment, the block number may include information on a block number regarding generation of the state data in the blockchain network. For example, when the block number is ‘2’, the block number may indicate a second block generated in the blockchain network.

TABLE 3

| | | Hash | Node | Block |
|---|---|---|---|---|
| Key Value | Data Value | Information | Information | Number |
| D1 Budget | 2 hundred | 387343 | First block | 2 |
| | million | | node, second | |
| | | | block node | |
| D1 Development | [D1 Plan] | 088722 | First block | 1 |
| Planning | | | node | |
| D2 Budget | 1 hundred | 154254 | Second block | 3 |
| | million | | node | |
| Total Budget | 3 hundred | 767673 | Second block | 4 |
| | million | | node | |

According to yet another embodiment, Table 3 shows state data which is included in the third block node 430. According to yet another embodiment, the third block node 430, which is a server node, may store all state data regarding the blockchain network. According to yet another embodiment, the third block node 430 may include information regarding the state data, but may not include a real data value. In another example, the third block node 430 may include a real data value.

According to yet another embodiment, the first block node 410 may acquire a transaction request 701 from a client of the blockchain network. For example, the first block node 410 may acquire a transaction request like ‘Modify D2 budget to 3 hundred million’. According to yet another embodiment, the first block node 410 which acquires the transaction performance request may be expressed as a transaction reader.

According to yet another embodiment, the first block node 410 may execute the first smart contract based on the transaction request (701) (702). According to yet another embodiment, the first block node 410 may determine whether data necessary for executing the first smart contract (702) is included in the first partial edger. For example, the first block node 410 may determine whether ‘D2 Budget’ is stored in the state database.

According to yet another embodiment, the first block node 410 may request information regarding block nodes that store the data necessary for executing the first smart contract (702), from the third block node 430, in order to acquire the data of ‘D2 Budget’ necessary for executing the first smart contract (702). For example, the first block node 410 may request a node list and hash information from the third block node 430 (703). According to yet another embodiment, the third block node 430 may detect a node list including information regarding block nodes owning the data, and hash information regarding the data in response to the request (703) (704). For example, the third block node 430 may detect a node list containing information regarding the second block node 420 owning the data of ‘D2 Budget’, and ‘154254’ which is hash information regarding ‘D2 Budget’.

According to yet another embodiment, the third block node 430 may transmit the detected node list, hash information to the first block node 410 (705). For example, the third block node 430 may transmit the node list including information regarding the second block node 420, and hash information of ‘154254’ regarding ‘D2 Budget’. In another example, when the third block node 430 stores a data value in the state database, the third block node 430 may transmit the node list, the hash information, and the data value to the first block node 410. For example, the third block node 430 may transmit not only the node list including information regarding the second block node 420 and the hash information of ‘154254’ regarding ‘D2 Budget’, but also ‘1 hundred million’ which is a data value of ‘D2 budget’ to the first block node 410.

According to yet another embodiment, when the third block node 430 does not store the data value, the first block node 410 may request a data value based on the node list and the hash information. For example, the first block node 410 may request the data from the second block node 420, based on the node list indicating that the second block node 420 includes the data necessary for executing the first smart contract. For example, the first block node 410 may request the data value regarding ‘D2 Budget’ from the second block node 420, based on the node list including information regarding the second block node 420 and the hash information of ‘154254’.

According to yet another embodiment, the second block node 420 may transmit the data value to the first block node 410 in response to the request (706) (707). For example, the second block node 420 may transmit ‘1 hundred million’ which is the data value of ‘D2 Budget’ to the first block node 410.

According to yet another embodiment, the first block node 410 may perform a validation operation by comparing the hash information acquired from the third block node 430 and hash information which is based on the acquired data value. That is, the first block node 410 may validate the data value based on the hash information. According to yet another embodiment, the validation operation (708) may be performed based on whether the hash information is identical. For example, when the hash information regarding the data value acquired from the second block node 420 and the hash information (for example, ‘154254’) acquired from the third block node 430 are different, the first block node 410 may determine that the acquired data is forged. When it is determined that the acquired data is forged, the first block node 410 may determine that the validation (708) fails. In yet another embodiment, when the validation (708) fails, the first block node 410 may terminate performing the transaction and may provide a notification regarding the transaction failure to the user.

According to yet another embodiment, when it is determined that the data necessary for executing the first smart contract is correctly acquired as a result of validating (708), the first block node 410 may finish performing the first smart contract by using the data. According to yet another embodiment, the data necessary for executing the first smart contract may be indicated by a first data set (for example, a read-set). Accordingly, the first data set may be generated to execute the first smart contract. According to yet another embodiment, as a result of executing the first smart contract, the data necessary for executing the first smart contract may be returned to the first data set. That is, as a result of executing the first smart contract, the first data set (for example, a read-set) may be generated (709). For example, the first data set including data that should be read in executing the first smart contract may be generated. For example, the first block node 410 may generate the first data set (including a data value, hash information, node information, and block number). Accordingly, the first block node 410 may generate (1 hundred million, 154254, the second block node 420, 3) as the first data set.

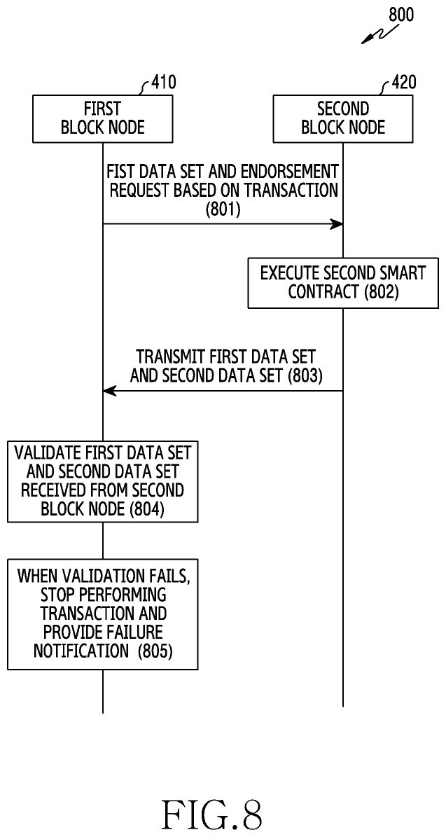

FIG. 8 is a flowchart to explain an endorsement operation regarding a transaction in a blockchain network according to an embodiment of the disclosure.

Referring to FIG. 8, a method 800 for performing an endorsement operation with other block nodes included in a blockchain network for a transaction agreement in the blockchain network is illustrated. According to an embodiment, a redundant explanation of the same contents as described in FIG. 7 may be omitted from FIG. 8.

According to an embodiment, the first block node 410 may transmit an endorsement request based on the transaction requested to be performed to the second block node 420, along with the first data set, in order to reach a transaction agreement. For example, the first block node 410 may transmit the first data set (for example, 1 hundred million, 154254, the second block node 420, 3), which is generated based on execution of the first smart contract, and an endorsement request regarding the transaction.

According to another embodiment, the second block node 420 may execute a second smart contract in response to the request (801) (802). According to yet another embodiment, when data necessary for executing the second smart contract (802) is stored in the partial ledger included in the second block node 420, the second block node 420 may execute the second smart contract by using data included in the second block node 420 (802).

According to yet another embodiment, the second block node 420 may generate the first data set and a second data set (for example, a write-set) according to execution of the second smart contract. According to yet another embodiment, the second data set may include data that will be updated when execution of the smart contract regarding the transaction is completed. For example, the second data set may include data that will be updated in the state database according to execution of the transaction like ‘Modify D2 budget to 3 hundred million’. For example, the second data set may include the D2 budget and the total budget which will be updated according to modification of D2 budget to 3 hundred million. In addition, the second data set may include a node list including information regarding a block node that should update the state database according to execution of the transaction, and information regarding a block number of a block generated based on execution of the transaction.

According to yet another embodiment, the second block node 420 may transmit the first data set and the second data set to the first block node 410 (803). For example, the second block node 420 may transmit the first data set and the second data set which are generated by execution of the second smart contract. For example, the second block node 420 may transmit the first data set including a data value, hash information, node information, and block number regarding ‘D2 Budget’. In addition, the second block node 420 may transmit the second data set including a data value, node information, and block information regarding data to be updated based execution of the transaction.

According to yet another embodiment, the first block node 410 may validate the first data set and the second data set which are received from the second block node 420. According to yet another embodiment, the first block node 410 may perform the validation operation based on at least hash information regarding the second data set. For example, the first block node 410 may perform the validation operation based on the hash information regarding the first data set and/or the second data set. For example, the first block node 410 may compare the first data set and the second data set regarding the first smart contract, which are generated by execution of the first smart contract, and the first data set and the second data set regarding the second smart contract, which are received from the second block node 420, and may perform the validation operation based on a result of comparing.

According to yet another embodiment, when the validation (804) fails, the first block node 410 may stop performing the transaction and may provide a failure notification (805). For example, the first block node 410 may provide a notification regarding failure in performing the transaction through a display (for example, the display 140 of FIG. 1) included in the first block node 410.

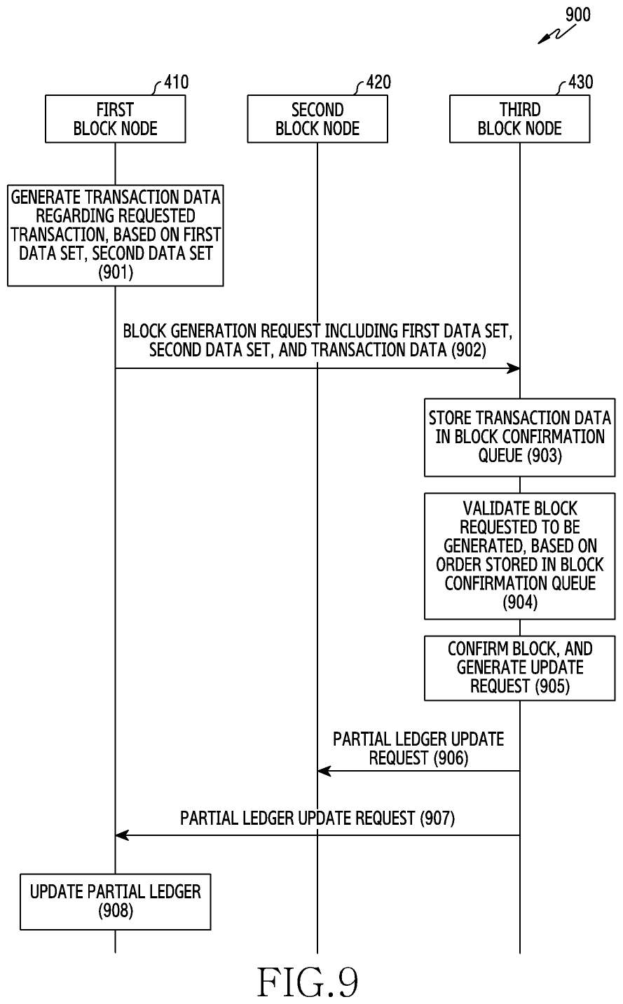

FIG. 9 is a flowchart to explain an operation of confirming a block in a blockchain network according to an embodiment of the disclosure.

Referring to FIG. 9, in a method 900, a process in which the first block node 410 requests the third block node 430 to confirm a block through the endorsement operation described with reference to FIG. 8, and confirms the block in the blockchain network is illustrated. According to an embodiment, the first block node 410 may generate data regarding the transaction requested to be performed based on the first data set, the second data set. For example, the first block node 410 may execute a smart contract regarding the transaction like ‘Modify D2 budget to 3 hundred million’, and may generate transaction data based on the first data set and the second data set.

According to another embodiment, the first block node 410 may transmit a block generation request 902 including the first data set, the second data set, and the transaction data to the third block node 430. According to yet another embodiment, the third block node 430 may store the transaction data in a block confirmation queue in response to the request (902) (903). According to various embodiments, the third block node 430 is not limited to the queue and may store the transaction data by using one of various material structures. According to yet another embodiment, the third block node 430 may perform a block generation operation in a first-in, first out method in an order stored in the block confirmation queue. The block generation operation may be expressed as ordering. According to yet another embodiment, the third block node 430 may validate a block which is requested to be generated, based on the order stored in the block confirmation queue. For example, the third block node 430 may generate a block based on the transaction data according to the order stored in the block confirmation queue, and may perform a validation operation on the block. The validation operation (904) may be performed by comparing data of the state database stored in the third block node 430 and block number, hash information of the first data set and the second data set. For example, the third block node 430 may compare hash information and block number stored in the state database of the third block node 430, and hash information and block number of the first data set, in order to perform the validation (904). In addition, the third block node 430 may compare node information of the second data set and block number of the second data set, and a node list and block number stored in the state database, respectively, in order to perform the validation (904). When both data are identical as a result of comparing, the third block node 430 may determine that the validation operation succeeds.

According to yet another embodiment, as the validation (904) succeeds, the third block node 430 may confirm the block and may generate an update request (905). For example, the third block node 430 may perform an agreement operation in order to confirm the validated block. For example, the third block node 430 may perform an agreement operation on the generated block with other block nodes included in the blockchain network 300, and may confirm the block when the agreement is completed. According to yet another embodiment, the third block node 430 may confirm the generated block as a validated block, and may connect the block to the blockchain of the full ledger included in the blockchain network as a node. In addition, the third block node 430 may generate an update request of the full ledger, partial ledger based on the confirmed block. For example, the third block node 430 may generate a request for updating of D2 budget and total budget included in the second data set, based on the block which is generated and confirmed by execution of the transaction ‘Modify D2 budget to 3 hundred million’.

According to yet another embodiment, the third block node 430 may transmit the generated update request to the block nodes included in the blockchain network. For example, the third block node 430 may request the second block node 420 to update the partial ledger. According to yet another embodiment, the second block node 420 may update the partial ledger in response to the request (906).

TABLE 4

| | | Hash | Node | Block |
|---|---|---|---|---|
| Key Value | Data Value | Information | Information | Number |
| D1 Budget | 2 hundred | 387343 | First block | 2 |
| | million | | node, second | |
| | | | block node | |
| D2 Budget | 3 hundred | 123456 | Second block | 5 |
| | million | | node | |
| Total Budget | 5 hundred | 789456 | Second block | 5 |
| | million | | node | |

Referring to Table 4, the second block node 420 may update the state database in response to the partial ledger update request (906). That is, the second block node 420 may update the partial ledger included in the second block node 420 (907). For example, in response to the transaction of ‘Modify D2 budget to 3 hundred million’ being executed, the second block node 420 may modify data the key value of which is ‘D2 Budget’. For example, the second block node 420 may update a data value regarding ‘D2 Budget’ stored in the state database to 3 hundred million. Accordingly, hash information and block number of ‘D2 Budget’ may be modified. In addition, the second block node 420 may update a value of ‘Total Budget’ based on ‘D2 Budget’ being updated. According to yet another embodiment, the second block node 420 may modify the data value of ‘Total Budget’ to 5 hundred million, and may update hash information and block number.

According to yet another embodiment, the third block node 430 may confirm the block, and may request all of the block nodes included in the blockchain network to update the partial ledger and/or full ledger. According to yet another embodiment, the block node that is requested to update the partial ledger and/or full ledger may update the partial ledger and/or full ledger based on the transaction that the block node itself is involved in. Accordingly, a node that has nothing to do with execution of the transaction in the blockchain network may maintain data included in the state database as it is, although there is a request for updating the partial ledger and/or full ledger.

According to yet another embodiment, the third block node 430 may request the first block node 410 to update the partial ledger. For example, the third block node 430 may request updating of the transaction of ‘Modify D2 budget to 3 hundred million’. According to yet another embodiment, the first block node 410 may update the partial ledger, based on the partial ledger update request (908). According to yet another embodiment, when the executed transaction has nothing to do with the first block node 410, the first block node 410 may not update. According to yet another embodiment, the state database of the third block node 430 may be updated according to confirmation of the block.

TABLE 5

| | | Hash | Node | Block |
|---|---|---|---|---|
| Key Value | Data Value | Information | Information | Number |
| D1 Budget | 2 hundred | 387343 | First block | 2 |
| | million | | node, second | |
| | | | block node | |
| D1 Development | [D1 Plan] | 088722 | First block | 1 |
| Planning | | | node | |
| D2 Budget | 3 hundred | 123456 | Second block | 5 |
| | million | | node | |
| Total Budget | 5 hundred | 789456 | Second block | 5 |
| | million | | node | |

Referring to Table 5, a state database which is stored in the third block node 430 is illustrated. According to yet another embodiment, the third block node 430 may include a data value or may not include the data value. According to an embodiment, as the block is confirmed through the transaction agreement, data included in the third block node 430 may be updated. For example, as the transaction is executed, ‘D2 Budget’ and ‘Total Budget’ may be updated based on ‘Modify D2 budget to 3 hundred million’.

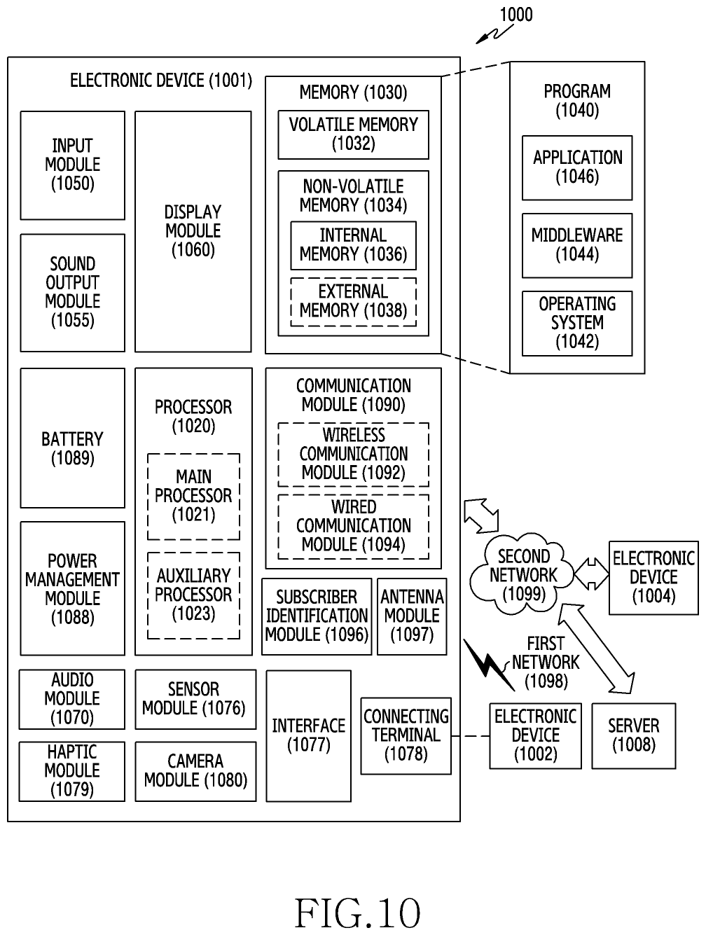

FIG. 10 is a block diagram illustrating an electronic device in a network environment according to an embodiment of the disclosure.

Referring to FIG. 10, an electronic device 1001 in a network environment 1000 may communicate with an electronic device 1002 via a first network 1098 (e.g., a short-range wireless communication network), or at least one of an electronic device 1004 or a server 1008 via a second network 1099 (e.g., a long-range wireless communication network). According to an embodiment, the electronic device 1001 may communicate with the electronic device 1004 via the server 1008. According to an embodiment, the electronic device 1001 may include a processor 1020, memory 1030, an input module 1050, a sound output module 1055, a display module 1060, an audio module 1070, a sensor module 1076, an interface 1077, a connecting terminal 1078, a haptic module 1079, a camera module 1080, a power management module 1088, a battery 1089, a communication module 1090, a subscriber identification module (SIM) 1096, or an antenna module 1097. In some embodiments, at least one of the components (e.g., the connecting terminal 1078) may be omitted from the electronic device 1001, or one or more other components may be added in the electronic device 1001. In some embodiments, some of the components (e.g., the sensor module 1076, the camera module 1080, or the antenna module 1097) may be implemented as a single component (e.g., the display module 1060).

The processor 1020 may execute, for example, software (e.g., a program 1040) to control at least one other component (e.g., a hardware or software component) of the electronic device 1001 coupled with the processor 1020, and may perform various data processing or computation. According to one embodiment, as at least part of the data processing or computation, the processor 1020 may store a command or data received from another component (e.g., the sensor module 1076 or the communication module 1090) in volatile memory 1032, process the command or the data stored in the volatile memory 1032, and store resulting data in non-volatile memory 1034. According to an embodiment, the processor 1020 may include a main processor 1021 (e.g., a central processing unit (CPU) or an application processor (AP)), or an auxiliary processor 1023 (e.g., a graphics processing unit (GPU), a neural processing unit (NPU), an image signal processor (ISP), a sensor hub processor, or a communication processor (CP)) that is operable independently from, or in conjunction with, the main processor 1021. For example, when the electronic device 1001 includes the main processor 1021 and the auxiliary processor 1023, the auxiliary processor 1023 may be adapted to consume less power than the main processor 1021, or to be specific to a specified function. The auxiliary processor 1023 may be implemented as separate from, or as part of the main processor 1021.

The auxiliary processor 1023 may control at least some of functions or states related to at least one component (e.g., the display module 1060, the sensor module 1076, or the communication module 1090) among the components of the electronic device 1001, instead of the main processor 1021 while the main processor 1021 is in an inactive (e.g., sleep) state, or together with the main processor 1021 while the main processor 1021 is in an active state (e.g., executing an application). According to an embodiment, the auxiliary processor 1023 (e.g., an image signal processor or a communication processor) may be implemented as part of another component (e.g., the camera module 1080 or the communication module 1090) functionally related to the auxiliary processor 1023. According to an embodiment, the auxiliary processor 1023 (e.g., the neural processing unit) may include a hardware structure specified for artificial intelligence model processing. An artificial intelligence model may be generated by machine learning. Such learning may be performed, e.g., by the electronic device 1001 where the artificial intelligence is performed or via a separate server (e.g., the server 1008). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 1030 may store various data used by at least one component (e.g., the processor 1020 or the sensor module 1076) of the electronic device 1001. The various data may include, for example, software (e.g., the program 1040) and input data or output data for a command related thereto. The memory 1030 may include the volatile memory 1032 or the non-volatile memory 1034.

The program 1040 may be stored in the memory 1030 as software, and may include, for example, an operating system (OS) 1042, middleware 1044, or an application 1046.

The input module 1050 may receive a command or data to be used by another component (e.g., the processor 1020) of the electronic device 1001, from the outside (e.g., a user) of the electronic device 1001. The input module 1050 may include, for example, a microphone, a mouse, a keyboard, a key (e.g., a button), or a digital pen (e.g., a stylus pen).

The sound output module 1055 may output sound signals to the outside of the electronic device 1001. The sound output module 1055 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 1060 may visually provide information to the outside (e.g., a user) of the electronic device 1001. The display module 1060 may include, for example, a display, a hologram device, or a projector and control circuitry to control a corresponding one of the display, hologram device, and projector. According to an embodiment, the display module 1060 may include a touch sensor adapted to detect a touch, or a pressure sensor adapted to measure the intensity of force incurred by the touch.

The audio module 1070 may convert a sound into an electrical signal and vice versa. According to an embodiment, the audio module 1070 may obtain the sound via the input module 1050, or output the sound via the sound output module 1055 or a headphone of an external electronic device (e.g., an electronic device 1002) directly (e.g., wiredly) or wirelessly coupled with the electronic device 1001.

The sensor module 1076 may detect an operational state (e.g., power or temperature) of the electronic device 1001 or an environmental state (e.g., a state of a user) external to the electronic device 1001, and then generate an electrical signal or data value corresponding to the detected state. According to an embodiment, the sensor module 1076 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 1077 may support one or more specified protocols to be used for the electronic device 1001 to be coupled with the external electronic device (e.g., the electronic device 1002) directly (e.g., wiredly) or wirelessly. According to an embodiment, the interface 1077 may include, for example, a high definition multimedia interface (HDMI), a universal serial bus (USB) interface, a secure digital (SD) card interface, or an audio interface.

A connecting terminal 1078 may include a connector via which the electronic device 1001 may be physically connected with the external electronic device (e.g., the electronic device 1002). According to an embodiment, the connecting terminal 1078 may include, for example, a HDMI connector, a USB connector, a SD card connector, or an audio connector (e.g., a headphone connector).

The haptic module 1079 may convert an electrical signal into a mechanical stimulus (e.g., a vibration or a movement) or electrical stimulus which may be recognized by a user via his tactile sensation or kinesthetic sensation. According to an embodiment, the haptic module 1079 may include, for example, a motor, a piezoelectric element, or an electric stimulator.

The camera module 1080 may capture a still image or moving images. According to an embodiment, the camera module 1080 may include one or more lenses, image sensors, image signal processors, or flashes.

The power management module 1088 may manage power supplied to the electronic device 1001. According to one embodiment, the power management module 1088 may be implemented as at least part of, for example, a power management integrated circuit (PMIC).

The battery 1089 may supply power to at least one component of the electronic device 1001. According to an embodiment, the battery 1089 may include, for example, a primary cell which is not rechargeable, a secondary cell which is rechargeable, or a fuel cell.

The communication module 1090 may support establishing a direct (e.g., wired) communication channel or a wireless communication channel between the electronic device 1001 and the external electronic device (e.g., the electronic device 1002, the electronic device 1004, or the server 1008) and performing communication via the established communication channel. The communication module 1090 may include one or more communication processors that are operable independently from the processor 1020 (e.g., the application processor (AP)) and supports a direct (e.g., wired) communication or a wireless communication. According to an embodiment, the communication module 1090 may include a wireless communication module 1092 (e.g., a cellular communication module, a short-range wireless communication module, or a global navigation satellite system (GNSS) communication module) or a wired communication module 1094 (e.g., a local area network (LAN) communication module or a power line communication (PLC) module). A corresponding one of these communication modules may communicate with the external electronic device via the first network 1098 (e.g., a short-range communication network, such as Bluetooth™, wireless-fidelity (Wi-Fi) direct, or infrared data association (IrDA)) or the second network 1099 (e.g., a long-range communication network, such as a legacy cellular network, a 5th generation (5G) network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 1092 may identify and authenticate the electronic device 1001 in a communication network, such as the first network 1098 or the second network 1099, using subscriber information (e.g., international mobile subscriber identity (IMSI)) stored in the subscriber identification module 1096.

The wireless communication module 1092 may support a 5G network, after a 4th generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 1092 may support a high-frequency band (e.g., the mmWave band) to achieve, e.g., a high data transmission rate. The wireless communication module 1092 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 1092 may support various requirements specified in the electronic device 1001, an external electronic device (e.g., the electronic device 1004), or a network system (e.g., the second network 1099). According to an embodiment, the wireless communication module 1092 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of lms or less) for implementing URLLC.

The antenna module 1097 may transmit or receive a signal or power to or from the outside (e.g., the external electronic device) of the electronic device 1001. According to an embodiment, the antenna module 1097 may include an antenna including a radiating element composed of a conductive material or a conductive pattern formed in or on a substrate (e.g., a printed circuit board (PCB)). According to an embodiment, the antenna module 1097 may include a plurality of antennas (e.g., array antennas). In such a case, at least one antenna appropriate for a communication scheme used in the communication network, such as the first network 1098 or the second network 1099, may be selected, for example, by the communication module 1090 (e.g., the wireless communication module 1092) from the plurality of antennas. The signal or the power may then be transmitted or received between the communication module 1090 and the external electronic device via the selected at least one antenna. According to an embodiment, another component (e.g., a radio frequency integrated circuit (RFIC)) other than the radiating element may be additionally formed as part of the antenna module 1097.

According to various embodiments, the antenna module 1097 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 1001 and the external electronic device 1004 via the server 1008 coupled with the second network 1099. Each of the electronic devices 1002 or 1004 may be a device of a same type as, or a different type, from the electronic device 1001. According to an embodiment, all or some of operations to be executed at the electronic device 1001 may be executed at one or more of the external electronic devices 1002 or 1004, or the server 1008. For example, if the electronic device 1001 should perform a function or a service automatically, or in response to a request from a user or another device, the electronic device 1001, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 1001. The electronic device 1001 may provide the outcome, with or without further processing of the outcome, as at least part of a reply to the request. To that end, a cloud computing, distributed computing, mobile edge computing (MEC), or client-server computing technology may be used, for example. The electronic device 1001 may provide ultra low-latency services using, e.g., distributed computing or mobile edge computing. In another embodiment, the external electronic device 1004 may include an internet-of-things (IoT) device. The server 1008 may be an intelligent server using machine learning and/or a neural network. According to an embodiment, the external electronic device 1004 or the server 1008 may be included in the second network 1099. The electronic device 1001 may be applied to intelligent services (e.g., smart home, smart city, smart car, or healthcare) based on 5G communication technology or IoT-related technology.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 1040) including one or more instructions that are stored in a storage medium (e.g., internal memory 1036 or external memory 1038) that is readable by a machine (e.g., the electronic device 1001). For example, a processor (e.g., the processor 1020) of the machine (e.g., the electronic device 1001) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device configuring a first block node included in a blockchain network, the electronic device comprising:
a communication circuit configured to transmit or receive a signal to or from a second block node or a third block node included in the blockchain network;
a memory configured to store a partial ledger, the partial ledger comprising a part of a full ledger regarding the blockchain network, the partial ledger comprising a first database; and
at least one processor electrically connected with the communication circuit and the memory,
wherein the at least one processor is configured to:
determine whether data necessary for executing a first smart contract regarding a transaction requested to be performed is stored in the first database,
based on a result of the determining, acquire node information comprising information regarding at least one block node that stores the data from the third block node through the communication circuit, and
acquire the data from the second block node or the third block node, based on the node information, and execute the first smart contract.

2. The electronic device of claim 1,
wherein the partial ledger comprises at least one block corresponding to at least one transection, on which the electronic device participates in an agreement, and
wherein the at least one block comprises a block hash comprising previous block information in the full ledger and previous block information in the partial ledger, and block data.

3. The electronic device of claim 2, wherein the first database is configured to store state data related to at least one transaction.

4. The electronic device of claim 1,
wherein the third block node comprises the full ledger comprising a second database,
wherein the second database is configured to store all state data regarding the blockchain network, and
wherein the at least one processor is configured to acquire the data from the third block node when the data is stored in the second database.

5. The electronic device of claim 1,
wherein the at least one processor is further configured to:
acquire hash information regarding the data from the third block node through the communication circuit, along with the node information,
transmit a first data set and an endorsement request comprising the transaction to the second block node,
receive an endorsement result comprising a second data set generated based on the endorsement request, and the first data set, from the second block node, and
validate the endorsement result based on the hash information,
wherein the first data set comprises data required to execute the first smart contract, and
wherein the second data set comprises data to be stored in the first database, based on execution of the first smart contract.

6. The electronic device of claim 5, wherein the second data set is generated by the second block node executing a second smart contract based on the first data set.

7. The electronic device of claim 6, wherein the at least one processor is further configured to:
generate transaction data regarding the transaction, based on the first data set and the second data set, with the endorsement result being validated,
transmit a block generation request comprising the first data set, the second data set, and the transaction data to the third block node,
receive an update request regarding the partial ledger and the first database, which is generated based on the block generation request, from the third block node, and
update the partial ledger and the first database based on the update request.

8. The electronic device of claim 7, wherein the update request is generated based on a result of comparing the first data set and the second data set which are generated from the third block node, and at least one of the hash information, block order information, a node list which are stored in the third block node.

9. A method of operating an electronic device configuring a first block node included in a blockchain network, the method comprising:
storing a partial ledger, the partial ledger comprising a part of a full ledger regarding the blockchain network, the partial ledger comprising a first database;
acquiring a request for performing a transaction;
determining whether data necessary for executing a first smart contract regarding the transaction is stored in the first database;
based on a result of the determining, acquiring node information regarding at least one block node that stores the data from a third block node;
acquiring the data from a second block node or the third block node, based on the node information; and
executing the first smart contract.

10. The method of claim 9,
wherein the partial ledger comprises at least one block corresponding to at least one transection, on which the electronic device participates in an agreement, and
wherein storing comprises:
storing the at least one block comprising a block hash comprising previous block information in the full ledger and previous block information in the partial ledger, and block data; and
storing state data related to at least one transaction.

11. The method of claim 9,
wherein the third block node comprises the full ledger comprising a second database which stores all state data regarding the blockchain network, and
wherein acquiring the data comprises acquiring the data from the third block node in response to the data being stored in the second database.

12. The method of claim 9, further comprising:
transmitting a first data set and an endorsement request comprising the transaction to the second block node;
receiving an endorsement result comprising a second data set generated based on the endorsement request, and the first data set, from the second block node; and
validating the endorsement result based on hash information regarding the first data set and the second data set,
wherein the first data set comprises data required to execute the first smart contract, and
wherein the second data set comprises data to be stored in the first database, based on execution of the first smart contract.

13. The method of claim 12, wherein the second data set is generated by the second block node executing a second smart contract based on the first data set.

14. The method of claim 13, further comprising:
generating transaction data regarding the transaction, based on the first data set and the second data set, with the endorsement result being validated;
transmitting a block generation request comprising the first data set, the second data set, and the transaction data to the third block node;
receiving an update request regarding the partial ledger and the first database, which is generated based on the block generation request, from the third block node; and
updating the partial ledger and the first database, based on the update request.

15. The method of claim 14, wherein the update request is generated based on a result of comparing the first data set and the second data set which are generated from the third block node, and at least one of the hash information, block order information, a node list which are stored in the third block node.

16. A blockchain system comprising at least a first electronic device, a second electronic device, and a third electronic device as block chain nodes,
wherein the first electronic device comprises a partial ledger comprising a part of a full ledger regarding the block chain system, and a first database,
wherein, in response to a request for performing a transaction being received, the first electronic device is configured to determine whether data necessary for executing a first smart contract regarding the transaction is stored in the first database,
wherein the first electronic device is configured to acquire node information comprising at least one external device which stores the data, from the third electronic device, based on a result of the determining, and
wherein the first electronic device is configured to:
acquire the data based on the node information, and
execute the first smart contract by using the acquired data.

17. The blockchain system of claim 16,
wherein the first electronic device is configured to transmit a first data set and an endorsement request comprising the transaction to the second electronic device,
wherein the second electronic device is configured to generate a second data set based on the endorsement request, and to transmit an endorsement result comprising the second data set and the first data set to the first electronic device,
wherein the first electronic device is configured to validate the endorsement result,
wherein the first data set comprises data required to execute the first smart contract, and
wherein the second data set comprises data to be stored in the first database, based on execution of the first smart contract.

18. The blockchain system of claim 17,
wherein the first electronic device is configured to generate transaction data corresponding to the transaction, based on the first data set and the second data set, based on the endorsement result,
wherein the first electronic device is configured to transmit a block generation request comprising the first data set, the second data set, and the transaction data to the third electronic device, and
wherein the third electronic device is configured to:
compare the first data set and the second data set, and at least one of hash information, block order information, and a node list regarding the data which are stored in a memory of the third electronic device, and
confirm the block based on a result of the comparing.

19. The blockchain system of claim 18, wherein, in response to the block being confirmed, the third electronic device is configured to request electronic devices related to the transaction to update according to the confirmed block, among at least one electronic device included in the blockchain system as a blockchain node.

20. The blockchain system of claim 16,
wherein the full ledger of the blockchain system comprises at least one block corresponding to at least one transaction regarding the blockchain system, respectively,
wherein the at least one block comprises a block hash comprising previous block information in the full ledger and previous block information in the partial ledger, and
wherein the at least one block is connected in a directed acyclic graph (DAG) structure.
